(19) United States
(12) Patent Application Publication
(10) Pub. No.: US 2010/0273382 A1
(43) Pub. Date: Oct. 28, 2010

(54) ACOUSTIC AND FIRE RETARDANT FOAM COATING COMPOSITION FOR FIBROUS MAT

(76) Inventors: Malay Nandi, Littleton, CO (US); Souvik Nandi, Arvada, CO (US)

Correspondence Address: JOHNS MANVILLE, 10100 WEST UTE AVENUE, PO BOX 625005, LITTLETON, CO, 80162-5005, US

(21) Appl. No.: 12/431,540

(22) Filed: Apr. 28, 2009

(51) Int. Cl. B32B 5/18; B32B 5/02; C09K 21/14

(52) U.S. Cl. 442/76; 442/136; 252/608

(57) ABSTRACT

A acoustic and fire retardant foam coating composition for a fibrous mat which comprises (i) one or more fillers such as ceramic microspheres having a particle size of D90%≦300 μm, a density of less than 3 g/cm³ and hardness of at least 5 on the Moh's scale and (ii) one or more binders with each organic binder having a peak heat release rate of ≦1000 kW/m² as measured by ASTM E1354, flux 30 kW/m². A coated fiberglass mat comprising the coating composition has a FIGRA value of ≦120 W/s according to EN 13823, and a flame index of ≦25 and a smoke index of ≦50 according to ASTM E84 and a NRC (noise reduction coefficient) of ≧0.2 according to ASTM C423, mounting type A.

### FIELD OF ART

The present disclosure relates to mineral filler based open cell foam coating composition that is applicable to fibrous (i.e., woven or non-woven) mat, and more particularly to acoustic and fire retardant coating composition.

### BACKGROUND

Open cell foam coating compositions can be applied to various fibrous mats (e.g., fiberglass mats). Applications for such coated mats include, for example, sheathing—either external or internal (e.g., gypsum, stucco, concrete, wallboard, or tile backer), roofing, flooring, facers, ceiling tiles (e.g., low or high density foams, gypsum core, or concrete core), and laminated products (e.g., duct board).

However, to be considered for specific applications, often certain performance standards must be met. In particular, acoustic and fire retardant standards are of significant importance. Such performance standards include ASTM C423, mounting type A, NRC (noise reduction coefficient) 0.2 or more, the ASTM E84 (“Standard Test Method for Surface Burning Characteristics of Building Materials”) and, EN 13823 (“European Single Burning Item” or SBI) fire tests.

There are various patents related to coating/foam coating composition applicable to glass fiber mats. For example, U.S. Pat. No. 4,784,897 discloses a cover layer material on a matting or fabric basis for the manufacture of boards from liquid or liquid-containing starting components, covered bilaterally with cover layers, especially for the manufacture of gypsum boards and polyurethane (PU) hard foam boards; the matting or fabric having on one side a coating of 70 to 94 wt.-% of a powdered inorganic material and 6 to 30 wt.-%, absolutely dry weight, of a binding agent; U.S. Pat. Nos. 4,879,173 and 5,342,680 disclose coating compositions comprising “resinous binder”; and U.S. Pat. Nos. 5,112,678 and 6,77,0354 disclose coating compositions comprising “inorganic binder”.

In addition, U.S. Pat. Nos. 4,229,329, 4,495,238, 5,091,243, 5,965,257, and 6,858,550 disclose fire retardant coating compositions. For example, U.S. Pat. No. 4,229,329 discloses a fire retardant coating composition useful as a paint or as a mastic composed of ultrafine pulverized fly ash, a low viscosity vinyl acrylic type emulsion polymer as a binder and water, with the ultrafine fly ash preferably comprising 24-50% of the composition by weight, and U.S. Pat. No. 5,091,243 discloses a fire-resistant fabric suitable for use as a flame barrier comprising a flame durable textile fabric substrate formed of corespun yarns, the yarns comprising a core of flame resistant filament and a sheath of staple fibers, and an intumescent coating carried by one surface of the textile fabric substrate.

U.S. Pat. No. 6,858,550 discloses a fire resistant fabric material comprising a substrate having an ionic charge which is coated with a coating having essentially the same ionic charge. The coating consists essentially of a filler material comprising clay and a binder material. The substrate is preferably fiberglass. U.S. Pat. No. 6,858,550 discloses that the filler material may further comprise at least one additional filler selected from the group consisting of decabromodiphenyloxide, antimony trioxide, fly ash, charged calcium carbonate, mica, glass microspheres and ceramic microspheres and mixtures thereof and the binder material is preferably acrylic latex. U.S. Pat. No. 6,858,550 further discloses that decabromodiphenyloxide and antimony trioxide impart the following nonlimiting characteristics: (1) flame retardant properties, (2) capability of forming a char, and (3) capability of stopping the spread of flames.

However, the aforementioned patents do not disclose a open cell foam coating composition that improves acoustic (ASTM C423, mounting type A, NRC 0.2 or greater) and pass the fire properties (ASTM E84 and EN 13823). What is needed is a foam coating composition applicable to fibrous mats that improves and passes acoustic ASTM C423, and fire tests ASTM E84 and EN 13823

### SUMMARY

Provided is a acoustic and fire retardant open cell foam coating composition for a fibrous mat comprising (i) one or more fillers such as ceramic microspheres having a particle size of D90%≦300 μm, a density of less than 3 g/cm³ and hardness of at least 2 on the Moh's scale (ii) one or more binders with each organic binder having a peak heat release rate of ≦1000 kW/m² as measured by ASTM E1354, flux 30 kW/m². A coated fiberglass mat comprising the aforementioned coating composition has a FIGRA value of ≦120 W/s according to EN 13823, and a flame index of ≦25 and a smoke index of ≦50 according to ASTM E84 and, a NRC (noise reduction coefficient) of ≧0.2 according to ASTM C423, mounting type A

Such a open cell foam coating composition can offer a coated fibrous mat suitable for applications requiring that certain acoustic (i.e., ASTM C423, mounting type A, NRC 0.2 or greater) and fire performance standards (i.e., ASTM E84 and EN 13823 fire tests) be met. Since the open cell foam coating composition meets both the ASTM E84 and EN 13823 fire tests, it can be used in most any applications requiring fire retardancy.

### DETAILED DESCRIPTION

The presently disclosed acoustic insulating, fire retardant foam coating composition for a fibrous mat, comprises (i) one or more fillers, (ii) one or more binders with each organic binder having a peak heat release rate of ≦1000 kW/m² as measured by ASTM E1354, flux 30 kW/m². Preferably, at least filler are ceramic microspheres having a particle size of D90%≦300 μm, a density of ≦3 g/cm³ and hardness of ≧2 on the Moh's scale. A foam coated fiberglass mat comprising the coating composition has sound absorption 0.2 or greater (NRC), a FIGRA value of ≦120 W/s according to EN 13823, and a flame index of ≦25 and a smoke index of ≦50 according to ASTM E84. The coating composition when applied as foam provides open cell structure after processing. The open cell foam diameter is 30 μm or less. In an embodiment, the combination of all binders/organic components present in the foam coating composition has a peak heat release rate of ≦1000 kW/m² as measured by ASTM E1354, flux 30 kW/m². The foam coating composition essentially uniformly penetrates the surface of the mat and provides a unique combination of surface porosity and surface smoothness. The total solids of the coating composition can comprise, for example, between 40-60 weight %, preferably about 47 weight % filler solids, between 30-60 weight %, preferably about 45 weight % binder solids, and between 1-15 weight %, preferably 8 weight % additional component(s) solids (e.g., modifiers, surfactants, etc.).

Exemplary fillers suitable for use in the presently disclosed coating composition are microspheres, in particular hollow microspheres, glass bubbles, in particular hollow glass bubbles, calcium carbonate, clay, mica, aluminum trihydrate, talc, and mixtures thereof. Preferred fillers are particles which are hollow and/or porous particles. The shape of the particles is preferably spherical. In an embodiment, each of the fillers present in the coating composition has a peak heat release rate≦1000 kW/m² as measured by ASTM E1354, flux 30 kW/m².

Exemplary binders suitable for use in the presently disclosed coating composition are styrene-butadiene rubber (SBR), ethylene-vinyl chloride, polyvinylidenechloride, modified polyvinylchloride, polyvinyl alcohol, ethylene vinyl acetate (EVA), polyvinyl acetate, ethylacrylate-methylmethacrylate acrylic copolymer latex, non-carboxylated acrylic with acrylonitrile copolymer latex, carboxylated butyacrylic copolymer latex, urea-formaldehyde latex, melamine-formaldehyde latex, polyvinylchloride-acrylic latex, methylmethacrylate-styrene copolymer latex, styrene-acrylic copolymer latex, phenol-formaldehyde latex, vinyl-acrylic latex, polyacrylic acid latex, polysiloxane, aqueous silicone emulsion and mixtures thereof. In an embodiment, the binder is aqueous. The binder may comprise, for example, core-shell latex, polymer latex, and/or inorganic binder. In an embodiment wherein the binder comprises core-shell latex, the soft core can made of, for example, butadiene and/or butyl acrylate, and the shell can made of, for example, methyl methacrylate (MMA).

The foam coating composition can further comprise pigment (i.e., organic or inorganic), surfactants, organic additive (e.g., rheology modifier), inorganic additives (e.g., colorants, biocides, cross linkers and/or stabilizers, such as, for example, oxidative stabilizer), thickener, and/or water repellants. In an embodiment, each component (e.g., each organic component) comprising ≧0.1 weight % of the dried (i.e., applied) coating composition has a peak heat release rate of ≦1000 kW/m² as measured by ASTM E1354, flux 30 kW/m².

In a preferred embodiment, at least one filler being present in the foam coating composition consists of microspheres, in particular ceramic microspheres, which are solid or hollow particles, provided their particle diameter D90% is ≦300 μm, their density is from 0.1 to ≦3 g/cm³ and their hardness is ≧2 on the Moh's scale.

In a preferred embodiment, the microspheres are ceramic hollow microsphere particles.

In a further preferred embodiment, the ceramic microspheres have a particle diameter D90% of ≦125 μm, more preferred of ≦100 μm, in particular of ≦90 μm.

A further preferred class of ceramic microspheres have a Crush Strength of ≧1,000 psi, more preferred of ≧2,000 psi, most preferred of ≧3,000 psi.

In case the coated fiberglass mat coated with the coating composition comprising the aforementioned hollow ceramic microspheres in the coating composition should provide a good scrub and abrasion resistance it is preferred to use hollow ceramic microspheres with thick walls having a Crush Strength of ≧30,000 psi, more preferred of ≧40,000 psi, most preferred of ≧60,000 psi. Such thick wall hollow ceramic microspheres have preferably a bulk density of 1.5 to ≦3 g/cm³, in particular a density of 1.8 to 2.8 g/cm³, most preferred a density of 2.0 to 2.7 g/cm³. Exemplary thick wall hollow ceramic microspheres are available from 3M under the trade name Zeeosphere™.

A further preferred class of ceramic microspheres are hollow ceramic microspheres called “Cenosperes” which are minute, regular aluminosilicate spheres.

A further preferred class of ceramic microspheres with thinner walls having a bulk density of 0.1 to ≦1.0 g/cm³, in particular a density of 0.2 to 0.8 g/cm³, most preferred a density of 0.25 to 0.5 g/cm³. Exemplary thin wall hollow ceramic microspheres are available from Trelleborg AB under the trade name Fillite™.

The coating composition according to the instant invention is typically applied as foam having a density of 0.03 to 0.6 g/cm³, preferably having a density of 0.04 to 0.5 g/cm³. The typical average foam diameter is from 0.5 μm to 300 μm, preferably from 1 to 200 μm, most preferred from 5 μm to 100 μm, in particular preferred from 10 μm to 50 μm.

The coating composition according to the instant invention is preferably applied in amounts of ≦500 g/sq meter, more preferred in amounts of ≦400 g/sq meter.

The coating composition according to the instant invention preferably is applied in a thickness of ≦4 mm, more preferred of ≦3 mm.

The presently disclosed coating composition is applicable to fiberglass mat, which can be defined as a substrate comprising at least partially of non-woven glass fibers (e.g., ≦30 microns average diameter). Remaining content, if any, could be organic or inorganic fiber (such as, for example, poly propylene, poly(ethylene terephthalate), basalt, or wollastanite fiber) and/or resin (i.e., organic and/or inorganic). The presently disclosed coating composition is also applicable to mats comprised of bleached cellulosic fibers and/or fibers derived from a cellulosic material, continuous filament mat, and/or synthetic fiber (i.e., continuous or discontinuous) mat. Examples of synthetic fibers include, for example, nylon, polyester, and polyethylene. The presently disclosed coating composition could be applied by any established method, and the application could comprise one pass or multiple passes. Most preferably, the coating composition is applied as foam with the specific's describer above.

The presently disclosed coating composition is also applicable to any fibrous mat including woven fiberglass textile.

A coated fibrous mat comprising a fiberglass mat coated with the coating composition according to the instant shows that the ceramic microspheres being present in the coating composition provide additional defined air pockets along with the open cell foam structure. Such air pockets are regions having different densities and/or phases in addition, compared to the remainder of the coating. Hence, the sound traveling through such coated fibrous mat is better absorbed. This result's either in coatings which can be chosen thinner compared to coating not containing such ceramic microspheres or in coatings having an improved sound/noise absorbtion when compared with coatings having the same or similar thickness lacking such ceramic microspheres.

The following illustrative examples are intended to be non-limiting.

### EXAMPLES

Table 1, below, provides a typical coating composition according to the instant invention when applied as foam:

TABLE 1

| | | | | | amount dry | | | Volume |
|---|---|---|---|---|---|---|---|---|
| | | Solids % | g/ml | % in TS | wt | To Make (g) | Volume (ml) | fraction |
| Water | | 0.0% | 1.0 | | | 100.19 | 100.19 | 10.37% |
| Paranol AC 793 | Latex | 50.0% | 1.04 | 15.05% | 50.34 | 100.68 | 96.81 | 10.02% |
| Paranol AC 774 | Latex | 50.0% | 1.04 | 18.37% | 61.42 | 122.85 | 118.35 | 12.25% |
| Anquamine 419 | Crosslinker | 60.0% | 1.00 | 1.82% | 6.08 | 10.14 | 10.14 | 1.05% |
| MF-56 | Silicone Emulsion | 40.0% | 1.08 | 10.23% | 34.20 | 85.49 | 79.16 | 8.20% |
| Fillite 106 | Ceramics Bubbles | 100.0% | 0.40 | 14.17% | 47.40 | 47.40 | 118.49 | 12.27% |
| G200 | Ceramics Bubbles | 100.0% | 0.30 | 33.08% | 110.63 | 110.63 | 368.78 | 38.19% |
| Rheolate 278 | Thickener | 25.0% | 1.0 | 0.202% | 0.68 | 2.702 | 2.70 | 0.28% |
| Stanfax 320 | Foam stabilizer | 36.0% | 0.9 | 4.57% | 15.28 | 42.45 | 46.14 | 4.78% |
| Stanfax 318 | Foaming agent | 32.5% | 1.0 | 2.50% | 8.37 | 25.75 | 25.00 | 2.59% |
| | | | | 100.0% | 334.39 | 648.26 | 966 | 100.0% |

The standard fire test in USA is ASTM E-84 where it measures the total heat release in a given span of time. The use of good heat barrier/organic fire retardant along with the reduction of organic component in the coating composition is the usual approach. But this approach may not be successful for EN 13823.

This invention emphasizes on the use of organic ingredients with peak heat release rate equal to or less than 1000 kW/m² to achieve the desired fire retardant property instead of more traditional expensive inorganic and organic fire retardants. Table 2, below, provides the peak heat release rate of a typical coating composition according to the instant invention:

TABLE 2

| | HRR of Latex |
|---|---|
| | (ASTM E1354, |
| | kW/m², flux 30 |
| Latex Type | KW/M²) |
| Styrenebutadiene rubber | 1600 |
| Acrylic (V-29) | 585 |
| Ethylenevinylacetate (9100) | 497 |
| Polyvinyl chloride (650 × 18) | 12 |

The aqueous coating mixture is mechanically foamed and then coated on fibrous mat to provide acoustic effect. Typical foam density is between 0.05 and 0.4 g/c.c. Special care has been taken to make finer foam and reduce the open cell structure after processing. Typical average foam diameter is between 1 and 200 micron.

The ceramic microspheres generate defined air pockets in the foam structure, which provide more acoustic effect by increasing the number of phases in the path traveled by sound, hence, reduce the foam thickness and the coating weight. The ability to reduce coat weight is one of the key elements towards improved fire properties without addition of expensive organic/inorganic fire retardants

Experimental lab results show that the unique foam coating formulation when applied on a textile wall covering meets the NRC 0.2 or greater (ASTM C423, mounting type A), ASTM E-84 and EN 13823. Two similar products in wall covering application, although provides equivalent acoustic properties, do not qualify EN 13823 (Table 3).

TABLE 3
NRC vs. Coat Wt

| | | Total wt (g, | | | | |
|---|---|---|---|---|---|---|
| | Thickness | 99 mm circular | coat wt | | NRC ≧ 0.2 | Air permeability |
| | (in) | disc) | (gsm) | density (g/cc) | (ASTM 423C) | (CFM) |
| Sample 1 | 0.09 | 3.89 | 340 | 0.18 | Pass | 6 |
| Sample 2 | 0.08 | 3.58 | 300 | 0.18 | Fail | 5 |
| JM | 0.11 | 5.13 | 500 | 0.20 | Pass | 6 |
| Duracoustic ® | | | | | | |
| (Control) | | | | | | |
| Wall Carpet | ~0.23 | NA | NA | NA | Pass | NA |
| [e.g. Seabrook | | | | | | |
| (North America), | | | | | | |
| type AR132] | | | | | | |

Both the Sample 1 & 2 passes the laboratory version of EN 13823 fire test while the Wall Carpet and JM Duracoustic ® do not qualify EN13823.

While various embodiments have been described, it is to be understood that variations and modifications can be resorted to as will be apparent to those skilled in the art. Such variations and modifications are to be considered within the purview and scope of the claims appended hereto.

What is claimed is:

1. A acoustic and fire retardant foam coating composition for a fibrous mat comprising:
(i) one or more fillers; and
(ii) one or more binders with each organic binder having a peak heat release rate of ≦1000 kW/m² as measured by ASTM E1354, flux 30 kW/m²;
wherein a coated fiberglass mat comprising the coating composition has:
a FIGRA value of ≦120 W/s according to EN 13823, and
a flame index of ≦25 and a smoke index of ≦50 according to ASTM E84 and a NRC (noise reduction coefficient) of ≧0.2 according to ASTM C423, mounting type A.

2. The foam coating composition of claim 1, further comprising one or more components selected from the group consisting of pigments, surfactants, rheology modifiers, stabilizers, colorants, biocides, cross linkers, thickeners, water repellants, and mixtures thereof.

3. The foam coating composition of claim 1, wherein the one or more fillers are selected from the group consisting of microspheres, glass bubbles, calcium carbonate, mica, clay, aluminum trihydrate, talc, and mixtures thereof.

4. The foam coating composition of claim 1, wherein the one or more fillers are hollow particles.

5. The foam coating composition of claim 1, wherein the one or more fillers are hollow microspheres and/or hollow glass bubbles

6. The foam coating composition of claim 1, wherein each organic binder has a peak heat release rate of ≦600 kW/m² as measured by ASTM E1354, flux 30 kW/m².

7. The foam coating composition of claim 1, wherein each filler has a peak heat release rate of ≦1000 kW/m² as measured by ASTM E1354, flux 30 kW/m².

8. The foam coating composition of claim 1, wherein each organic component comprising at least 0.1 weight % of dried coating composition has a peak heat release rate of ≦1000 kW/m² as measured by ASTM E1354, flux 30 kW/m².

9. The foam coating composition of claim 1, wherein each component comprising at least 0.1 weight % of dried coating composition has a peak heat release rate of ≦1000 kW/m² as measured by ASTM E1354, flux 30 kW/m².

10. The foam coating composition of claim 1, wherein all components comprising at least 0.1 weight % of dried coating composition have a peak heat release rate of ≦600 kW/m² as measured by ASTM E1354, flux 30 kW/m².

11. The coating composition of claim 1, wherein the one or more binders are selected from the group consisting of styrene-butadiene rubber, ethylene-vinyl chloride, polyvinylidenechloride, modified polyvinylchloride, polyvinyl alcohol, ethylene vinyl acetate, polyvinyl acetate, ethylacrylate-methylmethacrylate acrylic copolymer latex, non-carboxylated acrylic with acrylonitrile copolymer latex, carboxylated butyacrylic copolymer latex, urea-formaldehyde latex, melamine-formaldehyde latex, polyvinylchloride-acrylic latex, methylmethacrylate-styrene copolymer latex, styrene-acrylic copolymer latex, phenol-formaldehyde latex, vinyl-acrylic latex, polyacrylic acid latex, polysiloxane, aqueous silicone emulsion, and mixtures thereof.

12. The foam coating composition of claim 1, wherein the one or more binders comprise core-shell latex.

13. The foam coating composition of claim 12, wherein the core-shell latex comprises a soft core comprising butadiene and/or butyl acrylate and a shell comprising methyl methacrylate.

14. The foam coating composition of claim 1, wherein the one or more binders comprise inorganic binder.

15. The foam coating composition of claim 1, wherein the one or more binders comprise one or more aqueous binders.

16. The foam coating composition of claim 1, wherein the coating composition does not comprise an organic fire retardant.

17. The coating composition of claim 1, wherein at least one filler has hollow particles.

18. The coating composition of claim 1, wherein at least one filler are microspheres/glass bubbles/balloons which are solid hollow particles.

19. The coating composition of claim 1, wherein at least one filler are microspheres which are hollow particles.

20. The coating composition of claim 1, wherein at least one filler are ceramic microspheres.

21. The coating composition of claim 1, wherein at least one filler are ceramic microspheres which are hollow particles.

22. The coating composition of claim 1, wherein at least one filler are ceramic microspheres having a particle diameter D90% of ≦300 μm.

23. The coating composition of claim 1, wherein at least one filler are ceramic microspheres having a particle diameter D90% of ≦125 μm.

24. The coating composition of claim 1, wherein at least one filler are ceramic microspheres having a Crush Strength of ≧1,000 psi.

25. The coating composition of claim 1, wherein at least one filler are ceramic microspheres having a Crush Strength of ≧3,000 psi.

26. The coating composition of claim 1, wherein at least one filler are ceramic microspheres having a Crush Strength of ≧30,000 psi.

27. The coating composition of claim 1, wherein at least one filler are ceramic microspheres having a bulk density of 0.1 to ≦5 g/cm³.

28. The coating composition of claim 1, wherein at least one filler are ceramic microspheres having a particle size of D90%≦300 μm, a density of less than 3 g/cm³ and hardness of at least 2 on the Moh's scale.

29. The coating composition of claim 1, wherein the coating is applied as foam having a density of 0.03 to 0.6 g/cm³.

30. The coating composition of claim 1, wherein the coating is applied as foam having a average foam diameter from 0.5 μm to 300 μm.

31. The coating composition of claim 1, wherein the coating is applied in amounts of ≦500 g/sq meter.

32. The coating composition of claim 1, wherein the coating is applied in a thickness of ≦4 mm.

33. A coated fibrous mat comprising a fiberglass mat coated with the coating composition of claim 1, said coated fibrous mat having a FIGRA value of ≦120 W/s according to EN 13823, and a flame index of ≦25 and a smoke index of ≦50 according to ASTM E84 and a NRC (noise reduction coefficient) of ≧0.2 according to ASTM C423, mounting type A.

34. The coated fibrous mat of claim 33, wherein the coated fibrous mat has an air permeability of ≦50 CFM.

35. The coated fibrous mat of claim 34, wherein the coated fibrous mat has:
a nominal air permeability at a given coat weight; and
a lower FIGRA value according to EN 13823, as compared to a coated fiberglass mat comprising an identical coating composition at an identical coat weight and having an air permeability lower than the nominal air permeability.

36. The coated fibrous mat of claim 35, wherein the nominal air permeability is ≦45 CFM.

37. The coated fibrous mat of claim 35, wherein the nominal air permeability is ≦20 CFM.

38. The coated fibrous mat of claim 35, wherein the nominal air permeability is ≦10 CFM.
